(19) United States
(12) Patent Application Publication
(10) Pub. No.: US 2010/0324820 A1
(43) Pub. Date: Dec. 23, 2010

(54) OBJECT LOCATION

(75) Inventors: Priscille Arhant-Wibaux, Pont-Pean (FR); Martinho Dos Santos, Thorigne-Fouillard (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 12/918,390

(22) PCT Filed: Feb. 6, 2009
(86) PCT No.: PCT/FR09/50191

§ 371 Date: Aug. 19, 2010

(30) Foreign Application Priority Data
Feb. 20, 2008 (FR) 0851096

(51) Int. Cl. G01C 21/00

(52) U.S. Cl. 701/213; 701/207

(57) ABSTRACT

The invention relates to a method of locating an object, comprising a step of locating an object and a step of verifying the existence of a pre-established connection between the location of the object and at least one place associated with the object. In the affirmative, a step of providing an information item dependent on at least one place resulting from the verification step.

### TECHNICAL FIELD

The invention relates to locating an object and especially to locating a mobile object. The mobile object in question is any device that may be located geographically by at least one location means. The object may be a mobile telephone, an electronic personal digital assistant (PDA), a navigation device installed in a vehicle, a contactless card, a badge, a laptop computer, etc.

Any location means may be used: location means using the GPS (Global Positioning System) satellite-based positioning system, location means using mobile telephone networks such as the EOTD (Enhanced Observed Time Difference) location means, the GSM cell identification system, triangulation, etc. More generally, the location means is able to obtain a location either by calculation or directly from a user knowing the location.

### PRIOR ART

In the remainder of the description, a location is judged imprecise if it departs from the real location by a predefined amount. Conversely, a location is judged precise when the difference between the measured location and the real location is less than a predefined value. The value in question is arbitrary and is generally chosen as a function of the required degree of precision.

There exist at present programs for visualizing the location of an object on a geographical map. The map appears on the screen with a zoom level defined by default. The map displayed on the screen is associated with a plurality of zoom levels that a user may select in order to obtain a moving toward or moving away effect. Thus when the user receives the map and a location of an object on the screen the zoom level may be increased to obtain an effect of moving toward or it may be reduced to obtain an effect of moving away.

Many location means exist and each such means is able to supply a more or less precise location. A difference, sometimes a very large difference, is often observed between the location obtained by a location means and the real position of the object. Moreover, this difference between the location obtained and the real position is accentuated if the user selects zoom levels offering a moving toward effect. Consequently, if the location provided is imprecise, the user has no possibility of selecting a zoom level offering a satisfactory moving toward effect.

Obtaining an erroneous location is unacceptable as much for the location service provider wishing to provide an optimum quality of service as for the service user.

The present invention offers a solution free of the above drawbacks.

### THE INVENTION

To this end, the invention provides a method of locating an object, including a step of locating an object, a step of verifying the existence of a connection between the location of the object and at least one place associated with the object, and if so a step of providing an information item as a function of at least one place resulting from the verification step.

Thus the invention offers the possibility, especially if the location means provide an imprecise location, of obtaining information relating to a location obtained by a location means, and more precisely relating to at least one place linked to the location of the object. It is therefore clear that the invention offers a solution that is relatively insensitive to the precision of the location means because, for a given place, the information obtained is the same whatever location means is used. Thus the invention compensates the lack of precision of some location means.

The information in question completes or replaces the location obtained by a location means.

In a variant, the connection concerns an overlap. In this variant, a connection exists when there is an at least partial overlap between the location and said at least one place associated with the object. The invention therefore covers situations in which a location or a place is interchangeably a coordinate point or an n-dimensional space (where n is an integer), i.e. an area, a volume, etc.

In one variant of the method, the information includes geographical information. This geographical information completes or replaces the location obtained by a location means. This feature is especially beneficial if the location obtained by the location means is imprecise because the geographical information provides a preselected geographical position independent of the precision of the location means that provide that location. For example, the user of the located object may establish beforehand that if it is located at a given place, the location information to be provided will be a position that the user has chosen. In other words, the location coming from a location means is transformed into geographical information that indicates a geographical position of the object, not a real geographical position but a predefined place that is a function of the place for which there exists a connection, in particular an overlap, with the current location of the object.

In a variant of the method, the information includes contextual information. This contextual information completes or replaces the location obtained by a location means. In this way, especially if that location is imprecise, representation of the location relative to a geographical map is no longer necessary. The contextual information may be of the type “Mr X is at work”.

The information, whether geographical or contextual, is interchangeably visual (textual, geometrical) information, sound information, or audiovisual information combining visual information and sound information.

A hardware aspect of the invention provides a data processing system including an object that may be located, the system being characterized in that it comprises:
means for locating the object;
means for verifying the existence of a connection between the location and at least one place associated with the object; and
means for supplying an information item as a function of at least one place.

Another hardware aspect of the invention provides a communications terminal characterized in that it includes means for providing an information item relating to a located object, the information item being a function of at least one predefined place linked to the location of the object.

In a variant, the terminal includes means for verifying the existence of a connection between the location and said at least one predefined place associated with the object. The verification means are in the terminal or in a data processing device adapted to communicate with the terminal.

Another hardware aspect of the invention provides a data processing device, such as a server, the device being characterized in that it includes:
means for verifying the existence of a connection between a location of an object and at least one place associated with the object; and
means for providing the verification result.

In a variant, the device includes means for providing an information item relating to the located object, the information item being a function of at least one place.

Note that, in the present application, the terms “terminal” and “data processing device” designate the same structure, namely a structure including at least one processor adapted to execute at least one program. In the present application, designating the same structure by two different terms facilitates understanding the invention.

The invention further provides a first computer program including code instructions that, when the program is executed by a processor, executes the step of providing information of the method as defined above.

The invention further provides a computer program including code instructions that, when the program is executed by a processor, executes the verification step of the method of the invention and a step of providing the verification result.

The invention can be better understood after reading the following description, given by way of example and with reference to the appended drawings.

### IN THE FIGURES

FIG. 1 represents a data processing system illustrating a method of one implementation of the invention for locating an object.

FIGS. 2a and 2b represent a view of a geographical map. FIG. 2a is a view of a map on which a location is displayed by means of a prior art method. FIG. 2b is a view of the same map on which appears an example of information provided by a method of the invention.

FIG. 3 is a flowchart showing the steps of a method of one implementation of the invention.

### DETAILED DESCRIPTION OF AN ILLUSTRATIVE EMBODIMENT OF THE INVENTION

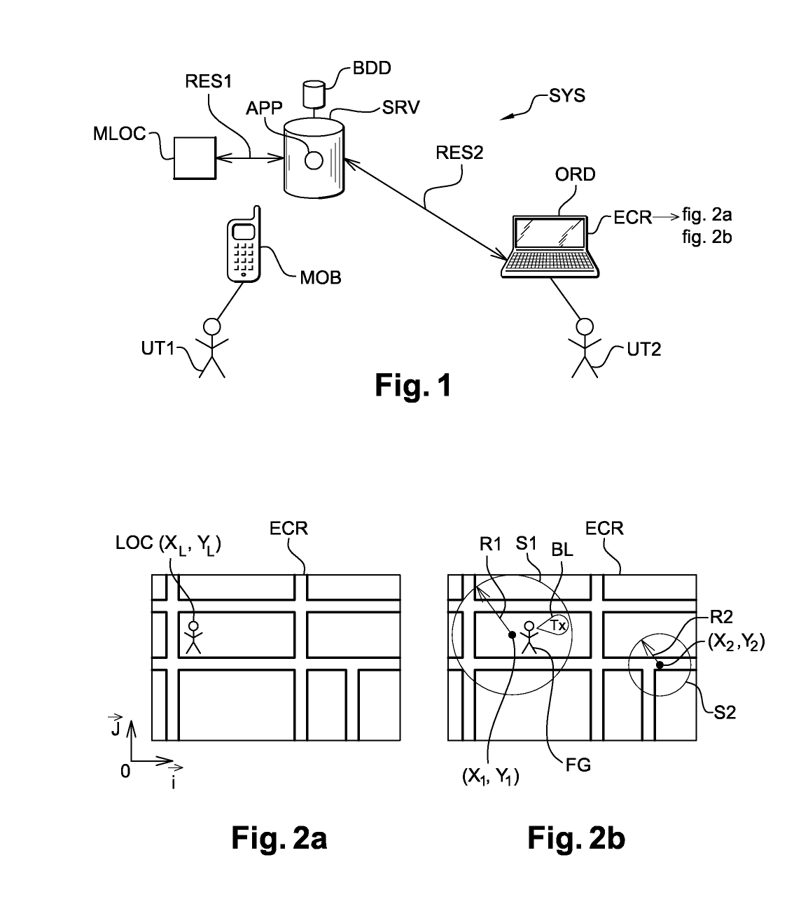

FIG. 1 represents a system SYS including an object MOB to be located, a location means MLOC, and a terminal such as a computer ORD including a screen ECR adapted to display a map and a location supplied by the location means. In this example, the object MOB is mobile. There is nevertheless nothing to prevent use of the invention with an object that is not mobile. In this example, the object MOB belongs to a first user UT1.

The system SYS includes a data processing device illustrated by means of a server SRV. The server SRV stores a location application APP able to request from a location means MLOC a location of the object and thus, indirectly, a location of the first user UT1 as they move around.

Note that a data processing device includes at least one microprocessor and physical and/or logical resources able to process data.

In this example, the server SRV communicates with the location means MLOC via a first network RES1 to obtain a relative location of the mobile object MOB. In this example, the location of the object corresponds to a coordinate point relative to a geographical map.

The server SRV communicates with the computer ORD via a second communications network RES2 of any type, which may be the first network RES1. In this example, the networks RES1 and RES2 are of Internet type.

FIGS. 2a and 2b represent two views of the same geographical map. A first view 2a illustrates the prior art and a second view represents visualization of a location by a method of the invention. In this example, the location is based on a system of spatial axes. For this purpose, the geographical map is associated with an orthogonal system of axes including a point 0 called the origin and the representations of three vectors \vec{i}, \vec{j} passing through the point 0 that respectively define the units and the directions “left-right”, and “vertical”. In this system of axes (0, \vec{i}, \vec{j}), to any point A there corresponds a unique doublet (Xn, Yn) called the coordinate point.

In the prior art, the location LOC with co-ordinates (XL, YL) is visible on the screen ECR and there is usually no indication as to the precision of the location displayed on the screen. If the location means used is imprecise, the difference between the measured location and the real location may be large and the user may not notice.

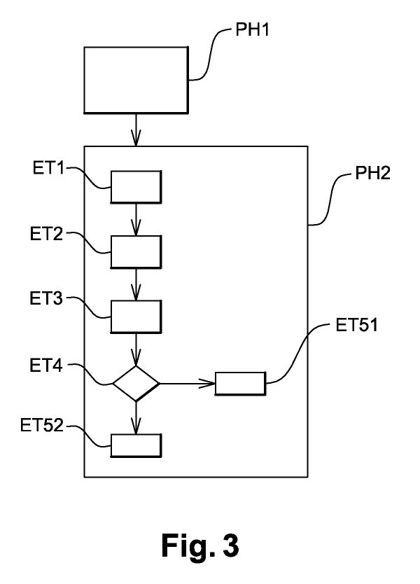

In FIG. 2b, the location displayed is not the location supplied by the location means but information that is the result of applying the method of the invention, one implementation of which is described with reference to FIG. 3. The FIG. 3 flowchart shows the steps of the method of the invention that transform the location as measured by a location means into information.

A first phase PH1 relates to defining of one or more places and associating at least one item of information with a respective place. This first phase PH1 is carried out for any number of objects that may be located. In this example, to simplify the explanation of the invention, the choice has been made to define two places associated with the object MOB, to which there correspond respective information items I1 and I2. Any number of places may be defined for an object, of course. The explanation of the invention is limited to a single object.

Consider for example that the two places defined for the object MOB are respective areas S1 and S2 represented by a circle centered on the points with coordinates (X1, Y1) and (X2, Y2), respectively, and of radius R1 and R2, respectively.

The predefined places and the associated information items may be grouped as in the following table:

| | | |
|---|---|---|
| Object MOB | S1 = (X1, Y1, R1) | Info item I1 |
| Object MOB | S2 = (X2, Y2, R2) | Info item I2 |

In the above table, if a connection exists between the location of the object MOB and the area S1, then the information item 11 is supplied to the second user UT2. If a connection exists between the location of the object MOB and the area S2, then the information item 12 is supplied to the second user UT2.

In this example, this table is stored in a database BDD connected to the server SRV.

In this example, a place is somewhere the first user UT1 is liable to be found. This place may be a workplace, the user's home, a restaurant, etc.

The information is interchangeably visual (textual, geometrical, etc.) information, sound information or audiovisual information combining visual information and sound information. In this example, the choice has been made to represent the information by means of a figure FG positioned at geographical coordinates associated with a place and accompanied by textual information TX of the “Workplace” type also associated with the place.

A second phase PH2 relates to locating the object MOB. This second phase PH2 is based on the first phase PH1 and comprises a plurality of steps.

Below the location LOC of the object is represented by a coordinate point and the location of the object is included in the area S1.

In a first step ET1, the second user UT2 requests from the server SRV a location of the object MOB.

During a second step ET2, the server interrogates the location means MLOC and obtains in return a location LOC of the object MOB.

In a third step ET3, the computer ORD receives a location from the server SRV.

During a fourth step ET4, a program, stored in the computer in this example, verifies the existence of a connection between the location and a predefined place associated with the object. In this example, the connection consists in verifying whether there is an at least partial overlap between the location LOC with coordinates (X_{L}, Y_{L}) obtained during the second step ET2 and a place (area S1 or S2) predefined during the first phase PH1. If not, the fourth step ET4 is followed by a step ET51 during which the location is displayed on the screen ECR in the same manner as in FIG. 2a.

Note that this fourth phase ET4 may be effected:
by the application APP on the server SRV; or
by the computer ORD; or
by any other device of the network.

In this example, this fourth phase being effected on the computer, there is provision for proceeding to the execution of the second phase of sending one or more places predefined during the first phase.

In this example, the location LOC with coordinates (XL, YL) obtained is included in the first area S1 and so there is therefore an overlap between the location LOC and the area S1. In this example, the fourth step ET4 is then followed by a step ET52 during which the information item I1 associated with the area S1 in question is supplied to the second user UT2. FIG. 2b shows an example of a resulting view. The information item I1 is visible in this view. In this example, the information item I1 associates a figure FG and a bubble BL including a text TX. The text TX is “Workplace”, for example, to indicate that the object, and thus indirectly that the first user UT1, is at the user's workplace. In this example, the position of the figure is predetermined during the phase PH1. This position may be defined by the user of the object MOB. The information item I1 could also be associated with a photo instead of the figure, in which photo the first user is shown at the office.

As indicated above, the invention is not limited to display on a screen and may consist in sending an SMS text message including the information, a voice message or any other means able to reproduce the information. The reproduction means may form part of the information associated with the place.

In a variant, the step ET51 could consist in advising the user that the location provided is imprecise, where appropriate specifying the levels of zoom that offer acceptable precision.

In a variant, the step ET51 could consist in informing the user that the location service is unavailable.

The information may be provided by any means, namely visually by means of a screen or a hologram, for example, or vocally, for example by means of a voice message, etc. The information reproduction means is able to understand at least part of the information item.

In a variant, the same place could be associated with a plurality of information items during the first phase PH1. During the second phase PH2, the selection of the information item to display could be a function of contextual data such as the appointment diary of the first user, the weather, the speed at which the object is moving, etc. The contextual data item provides an index as to the probability of locating a user at one place rather than another. For example, if the appointment diary of the first user UT1 indicates that a meeting is planned in a given conference room at a given time, and if location is effected during the meeting, the choice of the information item to provide from all of the information items associated with the place in question is a function of that context. For example, if the place is associated with two location information items of the type “at his desk” or “in a meeting”, in the preceding example, the information item displayed on the screen would be “in a meeting”.

In another variant, an overlap may exist between a location and a plurality of places. For example, an imprecise location may cover a plurality of places. The information item to be supplied to the second user UT2 is then a function of some or all of the places covering the location.

As indicated above, the fourth step ET4 of the method illustrating an example of a connection existing between a location and a place consists in verifying the existence of an at least partial overlap between the location and a predefined place associated with the object. A plurality of overlap situations may be envisaged.

A first situation in which the place corresponds to an n-dimensional space and the location is a coordinate point. In this first situation, if the place covers the location, then an overlap exists.

A second situation in which the place is a coordinate point and the location is an n-dimensional space. In this second situation, if the location covers the place, then there is an overlap.

A third situation in which the place and the location are two n-dimensional spaces. In this third situation, if at least one intersection exists between the two spaces, then there is an overlap.

The degree of overlap is predefined and may differ from one application to another. For example, the connection existing between a location and a place may consist in a verification that the location covers entirely the predefined place associated with the object. The connection existing between a location and a place may also consist in verifying that the predefined place associated with the object totally covers the location.

In another variant of the invention, the information item may also include a presence state. For example, if the first user is in a restaurant, the contextual information may include a presence state of the “do not disturb” type. The means employed to provide the presence information is then a presence server of operation that is known to the person skilled in the art.

Note also that the connection is not limited to the overlap example. For example, there may be a connection between a location and a place if the location and the place are different. More generally, the connection can be of any kind and is parameterable.

In a variant, during the first phase PH1 of the method described above, the pre-established connection between the location of the object and at least one place associated with the object can be produced by a training method. For example, if the object is located in the same area on a plurality of consecutive occasions, the method creates a connection either by prompting the user of the object to propose an information item linked to that area or by creating that connection automatically as a function of parameters such as the time at which the location was obtained. For example, if the object is at the same location each day during working hours, the training method associates with the area in question an information item linked to the work of the user of the object MOB. For example, this information item is “Mr . . . is at work”.

1. A method of locating an object, comprising a step of locating an object, a step of verifying the existence of a connection between the location of the object and at least one place associated with the object, and if so a step of providing an information item as a function of at least one place resulting from the verification step.

2. The method according to claim 1, wherein a connection exists when there is an at least partial overlap between the location and said at least one place associated with the object.

3. The method according to claim 1, wherein the information includes geographical information.

4. The method according to claim 1, wherein the information includes contextual information.

5. A data processing system comprising an object that may be located, the system comprising means for:
locating the object;
verifying the existence of a connection between the location and at least one place associated with the object; and
supplying an information item as a function of at least one place.

6. A communications terminal comprising means for providing an information item relating to a located object, the information item being a function of at least one predefined place linked to the location of the object.

7. The terminal according to claim 6, comprising means for verifying the existence of a connection between the location and said at least one predefined place associated with the object.

8. A data processing device comprising means for:
verifying the existence of a connection between a location of an object and at least one place associated with the object; and
providing the verification result.

9. The device according to claim 8, comprising means for providing an information item relating to the located object, the information item being a function of at least one place.

10. A computer program comprising code instructions that, when the program is executed by a processor, execute the step of provision of information of the method as defined in claim 1.

11. A computer program comprising code instructions that, when the program is executed by a processor, execute the verification step of the method as defined in claim 1 and a step of providing the verification result.
